(19) United States
(12) Patent Application Publication
(10) Pub. No.: US 2005/0148909 A1
(43) Pub. Date: Jul. 7, 2005

(54) Light weight chest compressor

(76) Inventors: Max Harry Weil, Rancho Mirage, CA (US); Joe Bisera, Camarillo, CA (US); Carlos Castillo, Palm Springs, CA (US)

Correspondence Address: LEON D. ROSEN;FREILICH, HORNBAKER & ROSEN, Suite 1220, 10960 Wilshire Blvd., Los Angeles, CA, 90024, US

(21) Appl. No.: 11/053,316

(22) Filed: Feb. 8, 2005

Related U.S. Application Data
(63) Continuation-in-part of application No. 10/621,481, filed on Jul. 15, 2003.

(51) Int. Cl. A61H 31/00

(52) U.S. Cl. 601/41; 601/44

(57) ABSTRACT

A portable chest compressor system for repeatedly compressing the chest of a patient to stimulate blood circulation and breathing, is of minimum weight and size. The system includes an energizable actuator (16) that repeatedly presses against the patient's chest and a stabilizer (130) that minimizes tilt of the actuator. The stabilizer is generally in the form of a resilient foam toroid to minimize weight, or an inflatable toroid, to minimize size and weight. The chest-compressing actuator includes a pneumatic cylinder-piston device that is driven by compressed breathing gas from a compressed air cylinder, to store a maximum of energy in a minimum of space and weight. The exhaust of the actuator is moderately pressured breathing gas that is delivered to the patient for breathing. The system minimizes the weight and volume of apparatus that must be carried by an emergency worker.

### CROSS-REFERENCE

This is a continuation-in-part of U.S. patent application Ser. No. 10/620,481 filed Jul. 16, 2003.

### BACKGROUND OF THE INVENTION

Many persons who suddenly become unconscious can be revived by applying chest compressions to stimulate blood circulation and breathing. Shocks applied by defibrillators can sometimes shock the heart into beating again. Chest compressions applied by hand are helpful, but are generally not as effective, or as reliably applied for long periods of time, as chest compressions applied cyclically by an automatic device. An automatic device can continue chest compressions while defibrillator shocks are applied and while the patient is loaded onto a stretcher and carried to an ambulance, and enables continued chest compressions while the patient travels in the ambulance even when other patients are in the ambulance who require the attention of a rescuer.

An emergency care worker generally must carry considerable equipment to the patient, and later carry it away with the patient. The amount of equipment to be carried is generally limited by the weight that a worker can carry. Equipment of large volume slows the worker even if he/she can carry it, and interferes with placing many patients in an ambulance, in a major disaster. An automatic chest compressor system of minimum size and weight would be of value.

### SUMMARY OF THE INVENTION

In accordance with one embodiment of the present invention, a chest compressor assembly is provided for automatically repeatedly compressing the chest of a patient to stimulate circulation and breathing, which is of minimum weight and volume. The system includes an actuator with a reciprocating member and means for cyclically energizing the reciprocating member to repeatedly apply a downward force to the patient's chest.

A stabilizer surrounds the actuator to prevent tilt. The stabilizer can be of foam to minimize weight, or can be an inflatable casing to minimize stored volume and weight. The exhaust from the actuator can be used to inflate an inflatable casing. Breathable gas from a pressured gas container can be used to drive the actuator. The breathable exhaust gas from the actuator can be delivered to the patient for breathing.

The use of a foam or inflatable stabilizer, the use of a container holding pressured gas to energize the actuator, and the reuse of exhaust breathable gas from the actuator to supply breathable gas to the patient, all minimize the weight and volume of equipment that the emergency worker must carry.

The novel features of the invention are set forth with particularity in the appended claims. The invention will be best understood from the following description when read in conjunction with the accompanying drawings.

### BRIEF DESCRIPTION OF THE DRAWINGS

FIG. 1 is an isometric view of an apparatus of the present invention for applying chest compressions to a patient, the apparatus being shown held to a patient who is shown in phantom lines.

FIG. 1A is an isometric view of an actuator that is altered from that of FIG. 1

FIG. 2 is a sectional view of the actuator of FIG. 1, and showing in phantom lines, the actuator in its fully depressed position.

FIG. 2A is a sectional view of an actuator modified from the actuator of FIG. 2

FIG. 3 is a graph showing movement of the lower end of the reciprocating member with time, using the apparatus of FIG. 2, and also showing, in phantom lines, movement when an upward force is not applied to the reciprocating member.

FIG. 4 is a plan view of the actuator of FIG. 1.

FIG. 5 is a sectional side view of an actuator of another embodiment of the invention, wherein the actuator comprises a bellows.

FIG. 6 is a sectional side view of a third embodiment of the invention, wherein pressured gas is used to push up the reciprocating member after each chest compression, and wherein the stabilizer is of foam.

### DESCRIPTION OF THE PREFERRED EMBODIMENTS

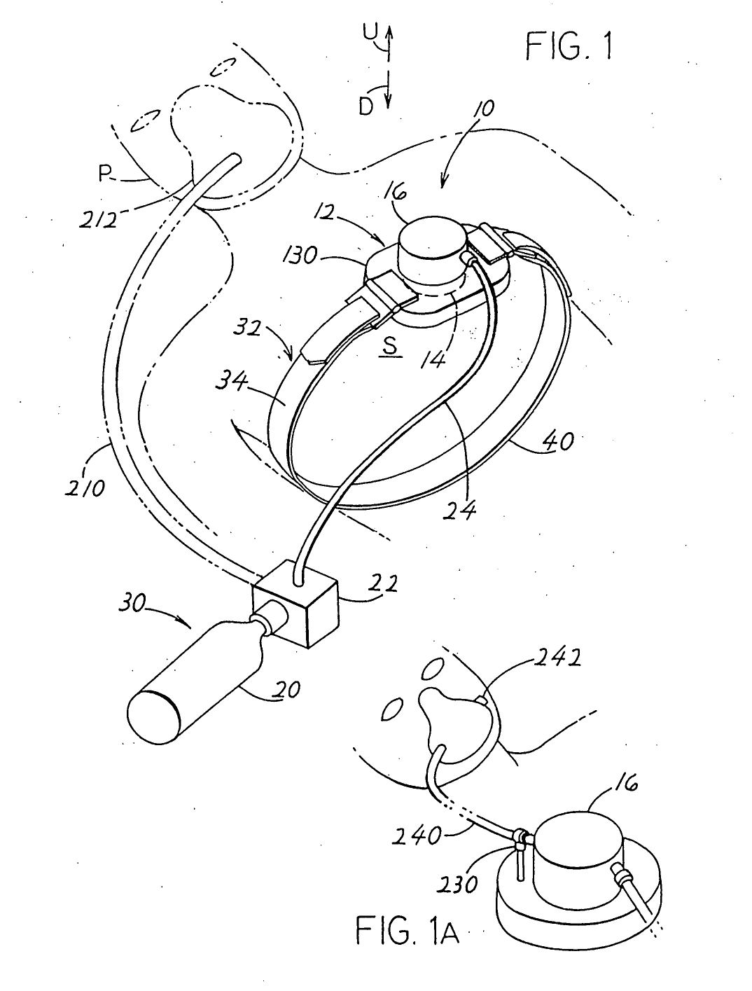

FIG. 1 illustrates a patient P who has dangerously low blood circulation such as might occur in a heart attack. An apparatus 10 of the invention includes a compressor assembly 12 with a reciprocating member 14 having a diameter of about 3 to 4 inches, which can be forcefully pushed down against the sternum S of the patient's chest in a series of regular pulses. The chest compressions stimulate the heart of the patient, which may cause a stopped heart to start again. The compressions also cause some circulation of blood, and also cause some breathing of the patient to supply oxygen to the bloodstream. For an adult male patient, depressing member 14 can press down with a maximum force of about 100 to 120 pounds, in pulses spaced by perhaps ½ to 1 second apart. The period of each cycle is preferably no more than about 1 second (i.e. less than two seconds). This mimics the chest compressions applied manually in CPR (cardiopulmonary resuscitation). For a child, the force is lower. The downward force is always more than 5 pounds during chest compression. A defibrillator (not shown) may also be applied to the patient.

The compressor assembly 12 includes an actuator 16 that forces down the reciprocating member 14 in pulses, a pressure source 20 that supplies pressured gas for energizing the actuator, and a control 22 that regulates the gas pressure and that controls the application of pressured gas to the actuator. The source 20 stores breathable gas, preferably with a higher concentration of oxygen (e.g. up to 100%) than is found in the atmosphere. An elongated flexible tube 24 connects a remote part 30 of the compressor assembly that lies on the ground, to the actuator 16 that lies over the patient's chest.

The apparatus 10 includes a torso wrap 32 which includes a belt or band 34 that extends around the upper torso of the patient. The belt has a back portion 40 that lies at the back of the patient. When the actuator 16 is energized and pushes depressing member 14 in a backward direction which is almost always downward D, the rest of actuator tends to move upward U relative to the patient.

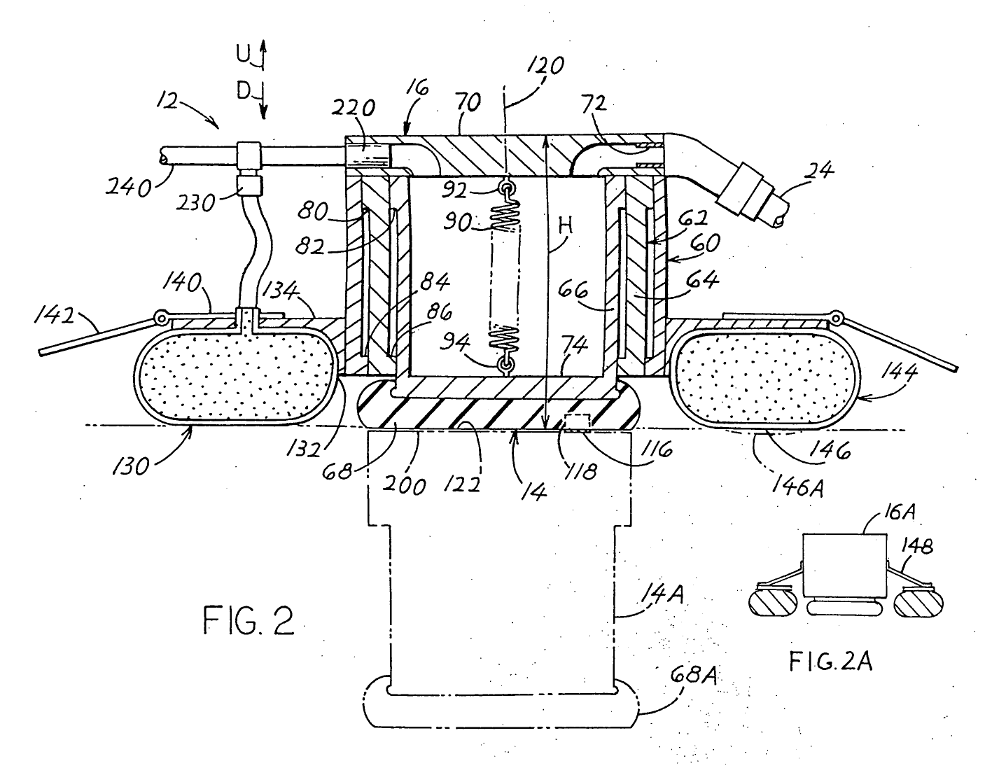

FIG. 2 shows details of the compressor assembly 12, including the actuator 16, which is energized by a fluid that is compressed gas and preferably compressed breathable gas. The actuator includes a frame or cylinder 60 and a piston assembly or piston 62 lying largely within the cylinder. The particular piston 62 includes two piston parts including upper and lower piston parts 64, 66. A cap 70, which is part of the cylinder, covers the top of the cylinder, and a pressing member 68 that is preferably of elastomeric material is mounted on the bottom of the reciprocating member 14 formed by the lower piston part 66. The pressing member can be fixed to the lower piston part, or pivotally mounted thereon to pivot about horizontal axes.

When pressured air or other gas is supplied through an inlet 72 to the inside of the cylinder 60, such pressured air presses downward against the lower piston part, especially its large bottom inner surface 74. This compresses the patient's chest. The maximum downward travel of the reciprocating member and pressing member 68 are shown at 14A and 68A. In the downward position, shoulders 80, 82 on the piston parts engage corresponding shoulders 84, 86, one on the cylinder and one on the upper or outer piston part. The inside diameter of the lower piston part 66 is more than half the inside diameter of the cylinder 60, so that a considerable downward force is applied to the patient's chest for a given air pressure in the cylinder.

After each downward thrust of the reciprocating member 14, it is moved up again to its initial position. Previously, this was accomplished by relying on the resilience of a person's chest area. To aid in raising the reciprocating member, applicant includes a means 90 for applying upward forces to the reciprocating member 14 to raise it. The particular means 90 in FIG. 2 is a tension spring lying in the cylinder, with top and bottom ends 92, 94 respectively connected to the cap 70 at the top of the piston, and to the part of the reciprocating member 14 formed by the lower piston part 66. The upward force supplied by the spring 90 counters sliding friction between the piston parts 64, 66 and between the upper piston part 64 and the cylinder 60, as well as countering the weight of the piston parts. This enables more rapid recovery of the chest towards its initial position.

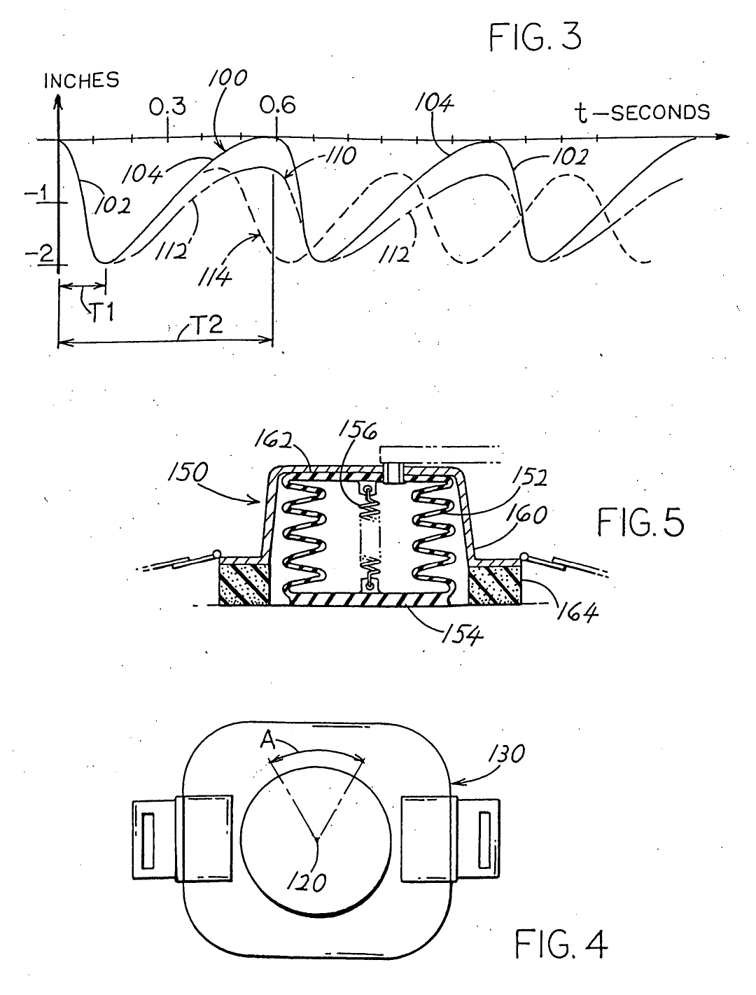

FIG. 3 includes a graph 100 that represents changes in position of the bottom of the reciprocating member with time during cyclic compression of a patient's chest. Graph parts 102 represent the chest compression portion of each cycle, while graph parts 104 represent recovery of the chest, where the compressing device includes the spring or uses air pressure, that lifts the reciprocating member. FIG. 3 includes another graph 110 with graph parts 112 representing recovery of the chest after each compression without assist. If the chest recovery must overcome friction in the piston parts, then a recovery will be somewhat slower without assist. For rapid cycling, which is indicated in FIG. 3 as a compression pulse every 0.6 second, the chest has not fully recovered along the recovery graph parts 112. As a result, each subsequent chest compression will be of smaller depth, such as 1.5 inches instead of two inches, resulting in somewhat less efficacy in heart stimulation, circulation and breathing. An alternative is to leave more time between subsequent chest compressions for the chest to recover, but this also results in reduced efficacy.

FIG. 3 also includes a graph 114 representing recovery (return to its upward position) aided by a spring that lifts the piston, but with a shorter cycle time of about 0.5 second and less chest recovery in each cycle. Tests show that the time periods T1 occupied by chest compressions, such as at 102 in FIG. 3, should be no more than one third (33⅓%) of each cycle. The chest compressions preferably occupy 10% to 30% of each cycle of duration T2, of chest compression followed by chest expansion.

To assure that the chest has recovered sufficiently before the next downward stroke, a detectable member 116 (FIG. 2) is attached to the patient's chest, and a proximity sensor 118 is mounted on the cylinder, as on the pressing member. The output of the sensor is delivered (through electrical wires) to the control 22.

The actuator 16 of FIG. 2 has a vertical axis 120 that should be maintained within about 5° from a vertical direction when the patient's chest location 122 that is being compressed lies in a horizontal plane. To prevent large tilt of the actuator, applicant provides a stabilizer 130. The stabilizer has a central hole 132 that receives the actuator, a top plate 134 on which are mounted fittings 140, 142 for attaching the belt, and an inflatable casing 144. The stabilizer is coupled to the actuator cylinder 60 so the stabilizer cannot move up and down, without limit relative to the actuator. When the means 90 for applying an upward force to the reciprocating member 14 raises the pressing part 68 flush with or above the level of the bottom 146 of the inflated casing, the bottom of the stabilizer presses against the patient. The stabilizer bottom lies at 146A, slightly below the bottom of the pressing member 68 when not deflected up. FIG. 2A shows a stabilizer connected by resilient beams 148 to the actuator 16A to allow limited relative vertical movement of the stabilizer.

As shown in FIG. 4, the stabilizer 130 extends completely around the axis 120 of the actuator 16. This avoids more than slight tilting of the actuator in any direction, that is, about any horizontal axis relative to the patient (assuming the patient's chest is horizontal). It would be possible to have small openings in the stabilizer, but a continuous opening should not exceed an angle A of more than 60°. Otherwise, the actuator 16 can tilt considerably, and cause trauma to the patient, as when a force of 100 to 120 pounds is applied at only one edge of the actuator.

The use of an inflatable stabilizer 130 has the advantage that the stabilizer has low weight, and takes up little volume when it is stored. Rescue workers generally have little spare space and are already loaded with heavy equipment, so minimizing weight and space is highly desirable. In one example, a solid rubber stabilizer of the shape of stabilizer 130 of FIG. 2, has a density of about 1 (water has a density of 1), an inside diameter of 4 inches, a volume of about 70 inch³, and a weight of about 2 pounds. An inflatable stabilizer has walls 148 with a weight of no more than 0.1 pounds or no more than one-tenth as much.

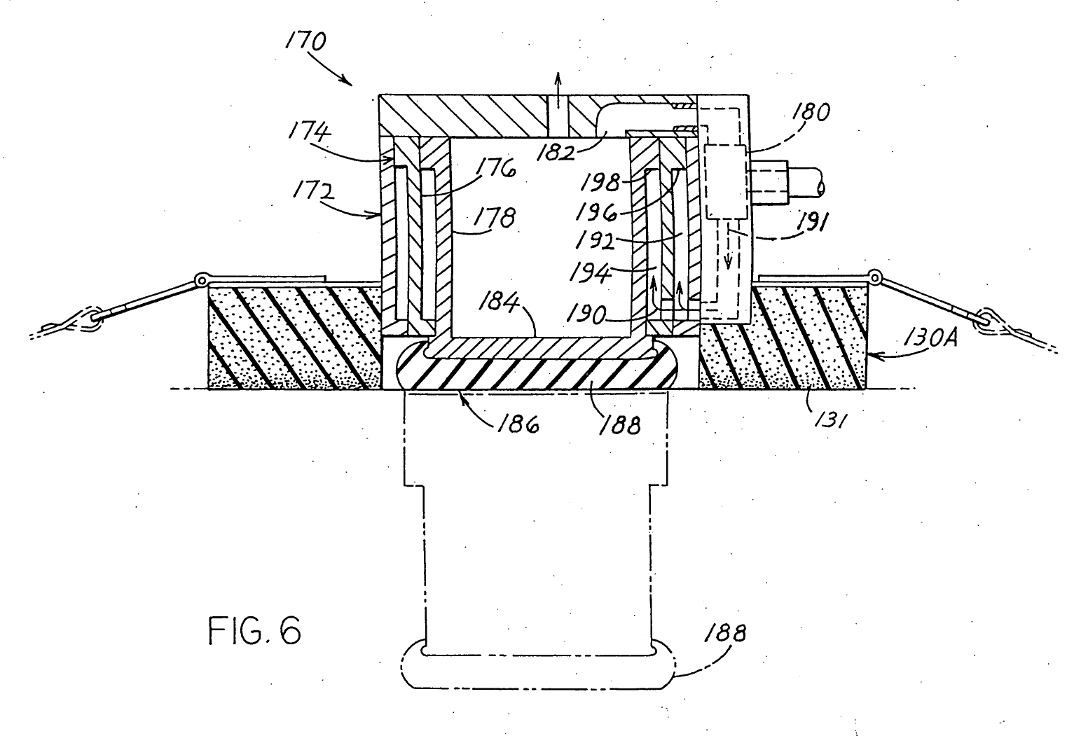

FIG. 6 shows a stabilizer 130A of foam 131, which is preferably resilient foam. The foam has a weight of 2 pounds per cubic feet, resulting in a density of about 0.05. The stabilizer 130A has a weight of no more than about 0.1 pound, which is less than one-tenth that of a solid rubber stabilizer, and with even greater resilience. Both the inflatable stabilizer (130, FIG. 2) and the resilient foam stabilizer (130A, FIG. 6) are elastomeric in that they each have the resilience of a mass with a Young's modulus of elasticity of no more than 50,000 psi. A rigid foam can be used, but a resilient foam is preferred. Both the foam and inflatable stabilizers have a density of no more than 0.2. Applicant notes that “resilient” does not mean “elastomeric”.

Applicant prefers to use the exhaust gas from the compressor 16 (FIG. 2) to perform as many functions as possible that require substantial power or gas pressure. The exhaust gas which exits through an outlet valve 220, is connected through a pressure limiter 230 to the inflatable stabilizer 130 (FIG. 2). When the compressor assembly first begins operating, the rescue worker can manually hold it upright. After perhaps two or three strokes, the stabilizer is inflated. Later, when the compressor assembly is turned off, the stabilizer automatically deflates through limiter 230 when a small force is applied.

FIG. 1 shows that part of the breathable gas in the pressure source 20 can be directed through a conduit or tube 210 to the patient mask (or to his trachea) to supply breathable gas to the patient's respiratory system. In FIG. 1A, applicant shows the exhaust gas from the compressor 16 being directed through a tube 240 (and a filter, not shown) to the patient mask. The gas passes through the mask to the patient, and can pass through a constriction 242 to the atmosphere. This better utilizes the compressed breathable gas from a pressure source. The mask can be placed on the patient a short time after the compressor starts operating.

FIG. 5 illustrates another apparatus 150 for compressing the chest of a patient. Instead of using a piston or telescoping pistons, the apparatus 150 includes an actuator 152 in the form of a bellows, with a reciprocating member 154. A tension spring 156 serves as a means for enhancing cycling by applying an upward force to the reciprocating member 154. However, it is possible to rely solely on the tendency of the bellows to return to its initial configuration. A metal frame 160 attaches an upper end 162 of the bellows to a foam stabilizer 164.

FIG. 6 illustrates another compressor apparatus 170 of a type that includes a cylinder 172 and a piston 174 in the form of inner and outer or upper and lower piston parts 176, 178. A pressure air valve 180 first applies pressured air at an outlet 182 leading to the lower surface 184 of the lower piston part 178 to depress a reciprocating member 186 and an elastomeric pressing member 188 attached to the reciprocating member.

When the pressing member 188 lies near its lowermost position, the valve 180 applies pressured air, as indicated by arrows 190, to spaces 192, 194 to push upward against surfaces 196, 198 to push up the piston parts. Such upward forces on the piston parts enable more rapid cycling, or cycling at a given rate that results in greater chest recovery in each cycle for greater depths of compression. The valve 180 can be electrically controlled by a controller such as 22 in FIG. 1. Advantages of applying pressured gas to raise the piston, are that a considerable upward force (e.g. 5 to 10 pounds) can be applied for rapid chest recovery, it is possible to vary the upward force (e.g. by controlling valve 180 to apply pressured gas more or less rapidly along path 191), and a spring force does not have to be overcome in depressing the piston.

Instead of applying pressure pulses along arrows 190 to raise the piston parts, it would be possible to apply vacuum pulses at the inlet 182 after each pressure pulse. However, a vacuum source is likely to add substantial weight to the system. In FIG. 6, the stabilizer 130A is formed of foam, and preferably of resilient elastomeric foam. Although the foam does not greatly reduce stored volume, as does an inflatable stabilizer, the foam is light in weight.

The actuators illustrated in FIGS. 2 and 6, which each have telescoping piston parts, are provided to minimize the height H (FIG. 2) of the compressor assembly 12. Some ambulances can be converted to a multi-patient configuration, wherein patients can be vertically stacked in the ambulance, so that a greater number of patients can be transported in the event of a disaster that produces multiple patients. Such stacking allows only a small vertical separation between patients. Any chest compressing assembly must have a small height in order to fit in the space allocated to each patient. Where a piston is used to compress the chest of a patient, the provision of a telescoping piston arrangement reduces the height and allows the apparatus to be used where limited vertical space is allowed.

The pressure source 20 in FIG. 1 can be a bottle of pressured oxygen (or an oxygen-air mixture). The control can be used to direct low pressure oxygen through a tube 210 leading to face mask 212. The pressure of the oxygen is used to power the chest compressing actuator 16. As discussed above and shown in FIG. 1A, the actuator 16 can be used to reduce the pressure of oxygen and to use the oxygen as a supply to the face mask or elsewhere to the patient's respiratory system (e.g. a tube extending into the mouth or nose). In FIG. 2, an outlet valve 220 is provided, which is sensitive to the flow of pressured gas through inlet 72, to open when the inflow stops. The upward movement of the piston expels reduced-pressure oxygen, which can be flowed to the face mask. The entire compressor assembly can be made of light weight materials (e.g. aluminum or carbon composite) to provide an assembly of not more than about 4 pounds that must be carried by an emergency worker. The light weight encourages the worker to carry the compressor assembly when he first approaches the patient, instead of having to go back to his ambulance to get it.

Thus, the invention provides apparatus for applying compressions to the chest of a patient to stimulate breathing and blood circulation, which includes an energizable actuator that repeatedly presses against the patient's chest area. The apparatus includes a stabilizer that lies around the actuator. The stabilizer is generally in the form of a toroid, which includes a portion that extends largely around the actuator and that has a central hole through which the actuator extends. The stabilizer is preferably formed of a pressured gas-filled casing or of resilient foam to avoid tilt in a lightweight stabilizer. It is preferable that there be no gap larger than 60° in the stabilizer, to avoid tipping of the actuator. The resilient stabilizer (foam or inflated) allows slight tilt without high concentrated force on the patient. The actuator includes a reciprocating member and means for cycling the member by alternately applying a downward force to the member and an upward force to it to raise it. The means for applying an upward force can include a tension spring lying in a cylinder or bellows, or an arrangement for applying pressured air to raise a piston. Pressured breathable (ordinary air or oxygen-rich) gas is used to move the reciprocating member, and the exhaust is directed to the patient for breathing and possibly also to an inflatable stabilizer that is carried in its uninflated state.

Although particular embodiments of the invention have been described and illustrated herein, it is recognized that modifications and variations may readily occur to those skilled in the art, and consequently, it is intended that the claims be interpreted to cover such modifications and equivalents.

1. Apparatus for applying compressions to the chest of a patient to at least stimulate blood circulation, which includes an energizable actuator that repeatedly presses against the patient's chest area, a torso wrap that is coupled to said actuator and that wraps to the back of the patient, and a stabilizer that lies around said actuator to minimize tilt of the actuator with respect to the patient's chest, wherein:
said stabilizer has a density that is no more than 0.5.

2. The apparatus described in claim 1 wherein:
said stabilizer is formed of an inflatable flexible casing containing pressured gas.

3. The apparatus described in claim 1, including:
a container of pressurized breathable gas connected to said actuator to energize it, and means for supplying said pressurized gas to said casing to inflate the casing.

4. The apparatus described in claim 1 wherein:
said stabilizer is formed of foam.

5. The apparatus described in claim 4 wherein:
said foam is a resilient foam that is elastomeric.

6. The apparatus described in claim 1 wherein:
said stabilizer is elastomeric and has a density of no more than 0.2.

7. The apparatus described in claim 1 including:
a container of breathable pressurized gas coupled to said actuator to energize it; and including
a conduit that carries gas exhausted from said actuator to the respiratory system of the patient.

8. The apparatus described in claim 1 wherein:
said actuator includes a stationary frame and a reciprocating member that lies within said frame and that moves up and down with respect to said frame, said frame being coupled to said stabilizer to limit vertical movement of said frame with respect to said stabilizer;
said stabilizer extends around said frame, without a gap in said stabilizer of more than 60°.

9. Apparatus for applying compressions to the chest of a patient to at least stimulate blood circulation, which includes an energizable actuator for repeatedly pressing against the patient's chest area, comprising:
a source of breathable pressurized gas and an actuator coupling for coupling said source to said actuator for energizing the actuator;
said actuator has an exhaust port, and including a patient coupling for coupling the exhaust port to the patient's respiratory system so the patient can breathe gas from the actuator.

10. The apparatus described in claim 9, including:
a stabilizer that completely surrounds said actuator without a gap of more than 60° and that presses against the patient's chest.

11. A method for applying pressure pulses to a patient's chest to stimulate blood circulation and breathing, by energizing an actuator that repeatedly applies downward forces to a reciprocating member relative to a frame to cause the member to depress the patient's chest, while also applying breathable gas to the patient, comprising:
supplying pressurized breathable gas to the actuator and exhausting gas from the actuator;
supplying at least some of said gas from the actuator to the patient for breathing by the patient.

12. The method described in claim 11 including:
inflating an inflatable stabilizer that extends around said actuator, with pressurized gas.

13. The method described in claim 12 wherein:
said step of inflating comprises inflating the stabilizer with said breathable gas.
